(19) United States
(12) Patent Application Publication
(10) Pub. No.: US 2017/0188738 A1
(43) Pub. Date: Jul. 6, 2017

(54) CURTAIN ROD EMBELLISHMENT APPARATUS

(71) Applicant: Kimberly Renee Walker, Sicklerville, NJ (US)

(72) Inventor: Kimberly Renee Walker, Sicklerville, NJ (US)

(21) Appl. No.: 15/461,454

(22) Filed: Mar. 16, 2017

Related U.S. Application Data
(60) Provisional application No. 62/318,682, filed on Apr. 5, 2016.
(60) Provisional application No. 62/322,713, filed on Apr. 14, 2016.

(51) Int. Cl. A47H 2/02; A47H 1/142; F21V 33/00; A47H 1/02

(52) U.S. Cl. CPC A47H 2/02; A47H 1/02; A47H 1/142; F21V 33/006

(57) ABSTRACT

The present invention uses a curtain rod embellishment apparatus to display, elegant, interchangeable, ornamental embellishments for visual enjoyment. The concept is an alternative for using tassels, scarf's, cornices or beads to compliment windows and room decor. A curtain rod embellishment apparatus, comprising at least two brackets; at least two curtain rod hooks; a curtain rod; an elongated element; at least one embellishment unit; wherein each of the at least two curtain rod hooks are secured with each of the at least two brackets, wherein the curtain rod is disposed at the at least two curtain rod hooks, wherein the elongated element has a front side and a back side opposite to the front side, wherein the at least two curtain rod hooks are secured with the back side of the elongated element, and wherein the at least one embellishment unit attachable to the front side of the elongated element.

### CROSS-REFERENCE RELATED TO RELATED APPLICATIONS

This application claims the benefit and priority of U.S. Provisional Application No. 62/318,682, filed Apr. 5, 2016, which is hereby incorporated herein by reference in its entirety. This application also claims the benefit and priority of U.S. Provisional Application No. 62/322,713, filed Apr. 14, 2016, which is hereby incorporated herein by reference in its entirety.

### BACKGROUND

Traditionally, windows are accessorized with cornices and valances which are custom made and are considered to be a permanent fixture, the present invention allows embellishments to be easily transposable to compliment room decor. In traditional inventions such as patent no. D547,167 S design are described as an ornamental rod, this design is specific to the end cap of a curtain rod.

### BRIEF SUMMARY OF THE INVENTION

This Brief Summary is included so as to introduce, in an abbreviated form, various topics to be elaborated upon below in the Detailed Description. This Brief Summary is not intended to identify key or essential aspects of the claimed invention. This brief Summary is similarly not intended for use as an aid in determining the scope of the claims. The present invention is directed to a curtain rod system. More specifically, the present invention relates to a curtain rod embellishment apparatus comprises at least two brackets; at least two curtain rod hooks; a curtain rod; an elongated element; at least one embellishment unit; wherein each of the at least two curtain rod hooks are secured with each of the at least two brackets, wherein the curtain rod is disposed at the at least two curtain rod hooks, wherein the elongated element has a front side and a back side opposite to the front side, wherein the at least two curtain rod hooks are secured with the back side of the elongated element, and wherein the at least one embellishment unit attachable to the front side of the elongated element. The Curtain rod embellishment apparatus displays elegant, interchangeable, large to small pieces of ornaments. The present invention is unconventional in which ornaments are displayed at lateral points on the curtain rod. The present invention allows the decorator more options to decorate by allowing the user to showcase ornamental collections to compliment room decor. There is a further need which allows embellishments to be displayed from a rod apparatus.

The advantage of the connecting system and the method according to the present invention is that embellishments can be easily attached to the curtain rod. This is accomplished by sliding elongated devices such as elongated shanks into the curtain rod entry points, then locking the apparatus into place with a fastening means. In some embodiments, the connecting system is comprised of a second curtain rod and is used for the sole purpose of hanging drapes. The curtain rod hangs below the ornamental designs and is held in place by brackets. An optional illumination apparatus is attached to the system.

### BRIEF DESCRIPTION OF THE DRAWINGS

It should be understood that the drawings are merely representative, are not necessarily drawn to scale, and are not intended to limit the subject matter of this application.

FIG. 1 is a perspective view of one of the preferred embodiment of a curtain rod embellishment apparatus with a plurality of entry points.

FIG. 1A shows a partial view of one embodiment of a curtain rod containing of an elongated element (also labeled as an elongated shank) with indentations or an opening on one end and a face at a second end.

FIG. 2 is a side view of one of the preferred embodiment of a curtain rod embellishment apparatus.

FIG. 3 illustrates top view of the preferred embodiment of a curtain rod embellishment apparatus.

FIG. 4 is a side view of one of the preferred embodiment of a curtain rod embellishment apparatus with optional illumination apparatus.

FIG. 5 is a perspective bottom view of one of the preferred embodiment of a curtain rod embellishment apparatus with optional illumination apparatus.

FIG. 6 is a side view of one of the preferred embodiment of a curtain rod embellishment apparatus with second curtain rod.

FIG. 7 is a perspective view of another embodiment of a curtain rod embellishment apparatus.

FIG. 7A is a sectional view showing the shape of the elongated element is square for both inner part and outer part.

FIG. 7B is a sectional view showing the shape of the elongated element is square for outer part and I-shape inner part.

FIG. 7C is a sectional view showing the shape of the elongated element is square for outer part and C-shape inner part.

FIG. 7D is a sectional view showing the shape of the elongated element is D-shape for both outer part and inner part.

### DETAILED DESCRIPTION

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Other than in the embodiment or example, or where indicated otherwise, all numbers indicating ingredient quantities and/or reaction conditions are to be understood as being modified in every instance by the word “about,” which means the ingredient quantities or reaction conditions are within 10 percent to 15 percent of the indicated value.

Unless defined otherwise, all terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” may also include the plural referents unless the context clearly dictates otherwise.

It is further noted that the claims may be drafted to exclude any element that may be optional. As such, this statement is intended to serve as antecedent basis for use of such exclusive terminology as “solely”, “only” and the like in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The invention relates to a new type of curtain rod-display which connects embellishments such as jewels or ornaments to a curtain rod system.

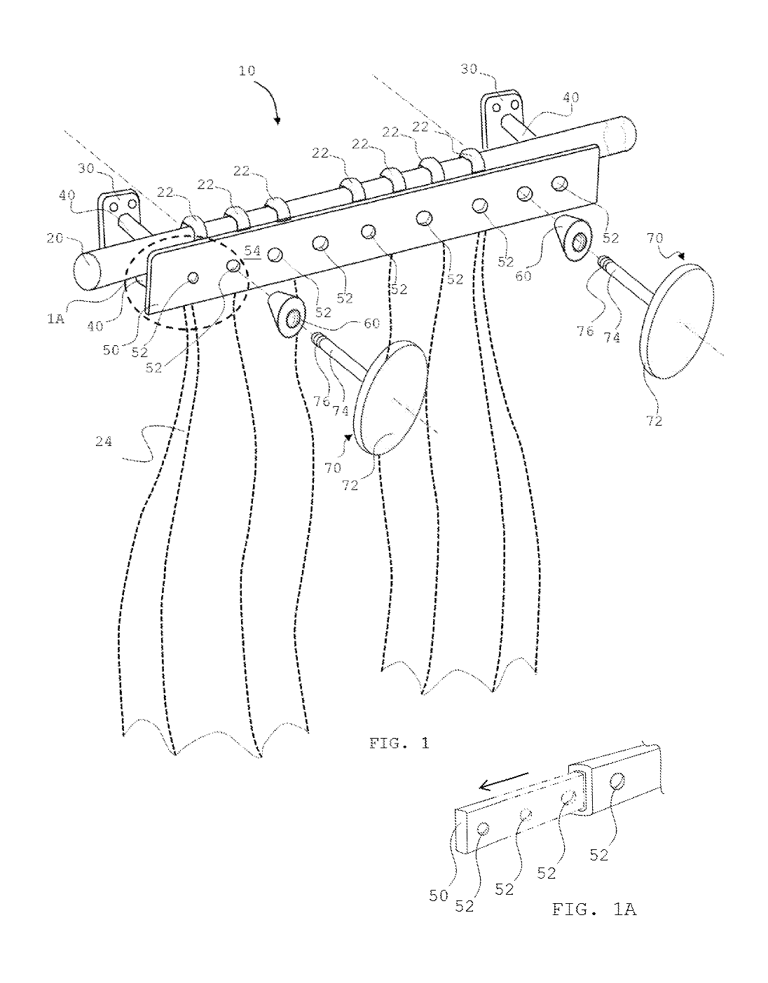

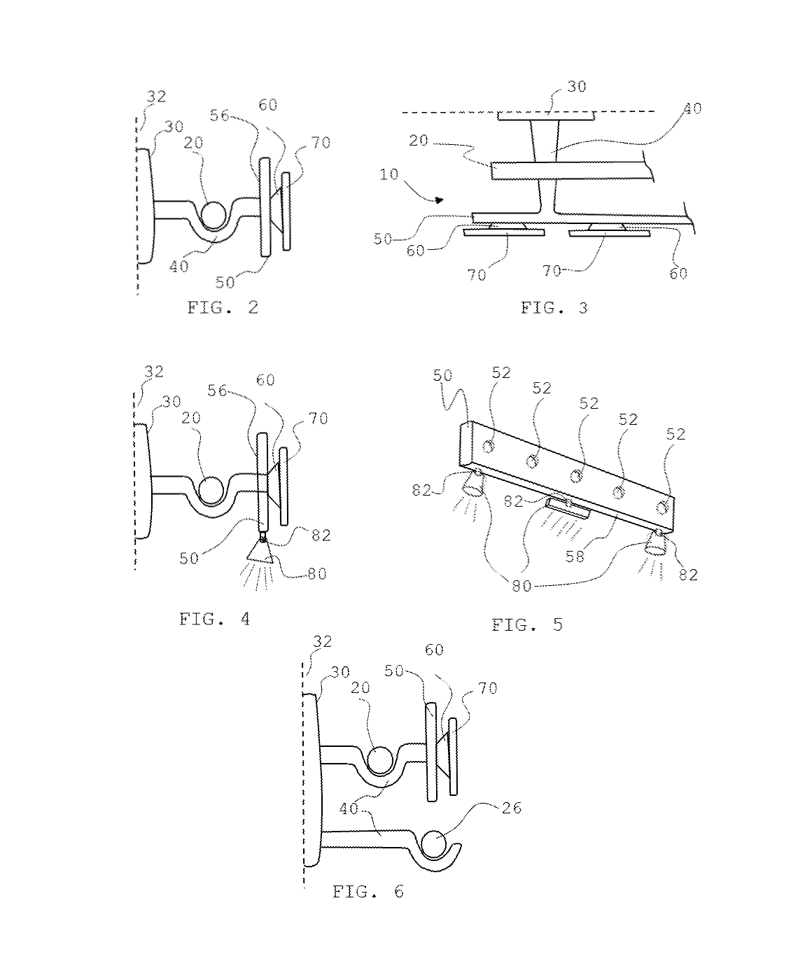

Referring to FIG. 1 and FIG. 2, one of preferred embodiments of the curtain rod embellishment apparatus comprises at least two brackets 30; at least two curtain rod hooks 40; a curtain rod 20; an elongated element 50; at least one embellishment unit 70; wherein each of the at least two curtain rod hooks 40 are secured with each of the at least two brackets 30, wherein the curtain rod 20 is disposed at the at least two curtain rod hooks 40, wherein the elongated element 50 has a front side 54 and a back side 56 opposite to the front side 54, wherein the at least two curtain rod hooks 40 are secured with the back side 56 of the elongated element 50, and wherein the at least one embellishment unit 70 attachable to the front side 54 of the elongated element 50. The material of the curtain rod 20 can be wood, plastics, metal, and a combination thereof, but preferable metal, such as stainless steel, chromes coated steel, brass, steel/brass/chrome, copper, iron, etc. In some embodiments, the curtain rod 20 may be in a shape of a substantially square cross sectional shape or round cross sectional shape and may have a light bend at the center to create an arch shape design.

Also referring to FIG. 1, the elongated element 50 may be an elongated shank which has a circle or round or other suitably shaped embellishment unit 70 on the front side 54. The embellishment unit 70 can be elegant, interchangeable, large to small pieces of ornaments for visual enjoyment. The embellishment unit 70 can be replaced or changed. The front side 54 is used to hold the embellishment unit 70 by an attachment means 100, such as but not limited to bolts, re-closable fastener, loop and hoop fastener, magnet, screw, clip, button, coupling, snaps, pin, spring clip, brat fastener, and re-attachable adhesive strip.

Referring to FIG. 1, a plurality of holes 52 are formed on the front side 54 of the elongated element 50, wherein at least a fastener 60 connects the embellishment unit 70 to one of the plurality of holes 52.

Referring to FIG. 1A, in one embodiment of the elongated element 50, it can be expended. Therefore, the curtain rod embellishment apparatus 10 can be adjustable in length.

Referring to FIG. 1A, in one embodiment of the curtain rod embellishment apparatus, wherein the elongated element 50 further comprises an outer part 51 and an inner part 53 extendable and retractable relatively to the outer part 51, and wherein the outer part 51 is secured to the at least two curtain rod hooks 40.

Also referring to FIG. 1, FIG. 2, and FIG. 3, the curtain rod embellishment apparatus 10 has curtain rod 20 resides on curtain rod hooks 40. An elongated element 50 is secured on the at least two curtain rod hook 40. In one of the embodiments, the curtain rod hooks 40 are secured on brackets 30 to a wall surface 32. The draperies 24, which is also commonly called curtain, is hanged on curtain rod 20 by a plurality of curtain rod clips 22.

In other embodiments, the fastener 60 may contain an opening or an aperture which may have male or female threading and is configured to slide onto the back side 56 of the elongated element 50 to secure shank into place on the curtain rod 20. Optional indentations on the end of the elongated element 50 may be threading allowing the fasteners 60 to fasten onto the elongated element 50. The present invention can be used indoor or outdoor to display Christmas ornaments. The present invention can be used as wall decor.

Referring to FIG. 4, the curtain rod 20 resides on curtain rod hooks 40. An elongated element 50, which can be also called shank, is secured on the at least two curtain rod hook 40. The curtain rod hooks 40 are secured on brackets 30 to a wall surface 32. The embellishment unit 70 is secured on the elongated element 50 by fastener 60. The elongated element 50 has a back side 56 and front side 54. The elongated element 50 has a plurality of opening formed on the front side 54. The embellishment unit 70 can be secured on the fastener 60 and to the elongated element 50. In one embodiment one illumination apparatus 80 can be attached to the elongated element 50 by a connector 82. Typically curtain or draperies 24 goes unnoticed due to their monotonous features. The illumination apparatus 80 enhances the beauty of the curtain rod embellishment apparatus 10 and the draperies 24 by illuminating the embellishment unit 70. The illumination apparatus 80 can be any type of lights or lamps suitable for household use, such as but not limited to Light Emitting Diode (LED) light, incandescent lamp, florescent lamp, sodium lamp, mercury lamp, and high pressure mercury vapor lamp. The optional illumination apparatus 80 can be powered by battery or household electricity. A preferred embodiment of the illumination apparatus 80 is battery powered LED lights so that no wiring is needed. The connector 82 can be any types of connection such as but not limited to hinges, clips, clamps, fasteners, hook and loop straps, magnetic fasteners, magnetic clasps, and hook.

Referring to FIG. 5, the illumination apparatus 80 is connected by connector 82 to the bottom 58 of the elongated element 50. The illumination apparatus 80 can be any type of lamps or lights suitable for household use in any type of shape, such as round, oval, rectangle, or square.

Referring to FIG. 6, in some embodiments, a second curtain rod 26 is positioned directly below the embellishment unit 70 to hang draperies 24 (not shown). In some embodiments, the second curtain rod 26 is connected using outer brackets 30 to the wall surface 32.

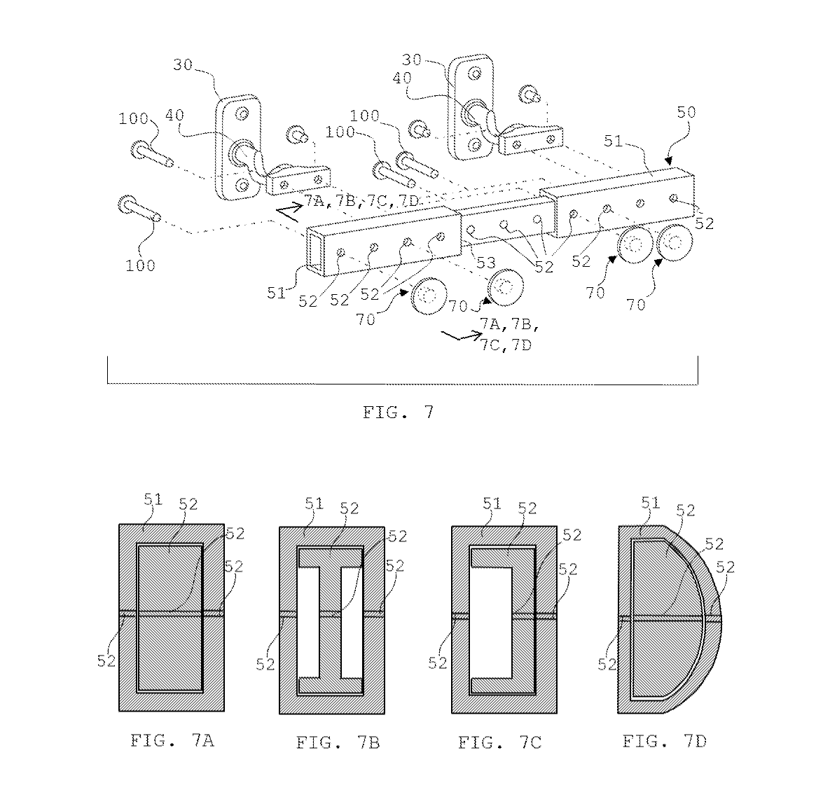

Referring to FIG. 7, one embodiment of the curtain rod embellishment apparatus with the attachment means 100 that is a screw to through the hole 52 to connect the embellishment unit 70 with the elongated element 50. Also, the at least two rod hooks 40 are attached to the at least two brackets 30. Also shown on FIG. 7 is one embodiment of the elongated element 50 with the outer part 51 and the inner part 53, which is extendable and retractable through the outer part 51.

Referring to FIG. 7A, 7B, 7C, and 7D, some embodiments of the elongated element 50 can be various shapes for the outer part 51, such as rectangle, D-shape, round, and the inner shape, such as rectangle, I-shape, C-shape, D-shape, round, or other geometrical shape.

What is claimed:

1. A curtain rod embellishment apparatus, comprising at least two brackets; at least two curtain rod hooks; a curtain rod; an elongated element; at least one embellishment unit;
wherein each of the at least two curtain rod hooks are secured with each of the at least two brackets,
wherein the curtain rod is disposed at the at least two curtain rod hooks,
wherein the elongated element has a front side and a back side opposite to the front side,
wherein the at least two curtain rod hooks are secured with the back side of the elongated element, and
wherein the at least one embellishment unit attachable to the front side of the elongated element.

2. The curtain rod embellishment apparatus of claim 1 further comprising an attachment means to attach and detach the at least one embellishment unit to the front side of the elongated elements.

3. The curtain rod embellishment apparatus of claim 2, wherein a plurality of holes are formed on the front side of the elongated element, wherein at least a fastener connects the embellishment unit to one of the plurality of holes.

4. The curtain rod embellishment apparatus of claim 1, wherein the elongated element further comprises an outer part and an inner part extendable and retractable relatively to the outer part, and wherein the outer part is secured to the at least two curtain rod hooks.

5. The curtain rod embellishment apparatus of claim 1, further comprising an attachment means to attach and detach a curtain to the curtain rod.

6. The curtain rod embellishment apparatus of claim 1, further comprising at least one illumination apparatus, and wherein the comprising at least one illumination apparatus is attached to the elongated element.

7. The curtain rod embellishment apparatus of claim 1, further comprising a second curtain rod, and wherein the second curtain rod is disposed at the at least two curtain rod hooks.

8. A curtain rod embellishment apparatus, comprising at least two brackets; at least two curtain rod hooks; a curtain rod; an elongated element; at least one embellishment unit;
wherein each of the at least two curtain rod hooks are secured with each of the at least two brackets,
wherein the curtain rod is disposed at the at least two curtain rod hooks,
wherein the elongated element has a front side and a back side opposite to the front side,
wherein the at least two curtain rod hooks are secured with the back side of the elongated element,
wherein the at least one embellishment unit attachable to the front side of the elongated element,
wherein a plurality of holes are formed on the front side of the elongated element, and wherein at least a fastener connects the embellishment unit to one of the plurality of holes.

9. The curtain rod embellishment apparatus of claim 8, wherein the elongated element further comprises an outer part and an inner part extendable and retractable relatively to the outer part, and wherein the outer part is secured to the at least two curtain rod hooks.

10. The curtain rod embellishment apparatus of claim 8, further comprising an attachment means to attach and detach a curtain to the curtain rod.

11. The curtain rod embellishment apparatus of claim 8, further comprising at least one illumination apparatus, and wherein the comprising at least one illumination apparatus is attached to the elongated element.
